(19) United States
(12) Patent Application Publication
(10) Pub. No.: US 2017/0246738 A1
(43) Pub. Date: Aug. 31, 2017

(54) Adjustable Rotating Tire Section Buffing Table

(71) Applicant: Bridgestone Americas Tire Operations, LLC, Nashville, TN (US)

(72) Inventors: Freddie Gonzalez, Jr., Brunswick, OH (US); Anthony B. Duncan, Wadsworth, OH (US); Kurt D. Willoughby, Danvers, IL (US); Eric L. Finger, Decatur, IL (US)

(21) Appl. No.: 15/505,208

(22) PCT Filed: Sep. 24, 2015
(86) PCT No.: PCT/US15/51841

§ 371 Date: Feb. 20, 2017

Related U.S. Application Data
(60) Provisional application No. 62/064,784, filed on Oct. 16, 2014.

(51) Int. Cl. B25H 1/04; B25H 1/10; B60C 25/05; B25H 1/00

(52) U.S. Cl. CPC B25H 1/04; B25H 1/0035; B25H 1/10; B60C 25/0545; B25H 1/02

(57) ABSTRACT

A table comprising a worktop including an axis of rotation, a perimeter, and an effective radius, the effective radius defined as the average distance between the axis of rotation and the perimeter; a frame; a rotational connection disposed between the worktop and the frame, the connection configured to allow the worktop to rotate about the axis of rotation; and a plurality of bearings disposed between the worktop and the frame to rollingly support the worktop on the frame, at least one of the bearings disposed more than half of the effective radius from the axis of rotation.

### BACKGROUND OF THE INVENTION

1. Field of the Invention

The present invention relates generally to adjustable work tables, and more particularly to such a table suitable for use in buffing a cross-section of a tire.

2. Description of the Prior Art

Tires are used in a multitude of applications including agricultural devices, construction equipment, personal automobiles, and airplane landing gear etc. Tires are designed and vigorously tested to optimize performance in their intended application. Tires are constructed with a variety of materials and structural features such as circumferential steel belts, beads, various layers of rubber, and tread. During testing, it is often desirable to inspect the internal features of the tire for indications of wear and failure or to better understand the design of a competitor's tire. Therefore, it may be desirable to selectively cut a cross section of a tire to better view the condition and configuration of the internal features. However, the process of cutting a tire cross section does not always result in a clean and smooth cut surface because of the non-homogenous nature of tire design and the varying strengths of the materials used in tire construction. To better inspect the internal features of the tire, it is desirable to further improve the quality e.g. uniformity and smoothness of the tire section by buffing the newly cut surface.

### SUMMARY OF THE INVENTION

This Summary is intended to introduce and outline select features only, and is not intended to identify critical or necessary features.

A table for supporting and selectively positioning a heavy work piece may comprise a worktop rotatably supported on a frame and a leveling mechanism for locking and leveling the rotatable worktop in a selected position.

A user may place the work piece on the worktop, rotate the worktop to a selected position, and lock the worktop in the selected position to better access the work piece. The frame may also be configured to selectively raise and lower the worktop. The table may further comprise a plurality of selectively attachable extensions. The user may selectively attach the extensions so that a work piece larger than the worktop may be supported on the worktop and one or more of the extensions.

The table may be particularly useful for supporting and selectively positioning a tire section while a user buffs the tire section. In one embodiment, the table comprises a worktop, a frame, a rotational connection, and a plurality of bearings rotatably supporting the worktop on the frame. At least one of the bearings may be disposed near the perimeter of the worktop which may provide improved stability of the worktop. The rotational connection may rotatably connect the worktop and the frame. The worktop may be selectively rotated about the rotational connection to orient the work piece in a selected orientation. The worktop may have a circular shape and the axis of rotation may be defined at the center of the worktop.

The leveling mechanism of the table may include a plurality of leveling mounts and a plurality of leveling mount supports. The leveling mount supports may be configured to selectively raise a respective one of the mounts to contact the worktop and prevent rotation of the worktop in the selected orientation. The worktop may then be leveled by further raising the leveling mounts to bear against the worktop.

The frame may be configured to selectively raise and lower the worktop. The frame may include a bottom frame member, a top frame member, and a plurality of vertical frame members. The vertical frame members may be disposed radially near the perimeter of the worktop to provide improved stability of the worktop.

The table may include rollers for translating the table and roller supports for attaching the rollers to the bottom frame member. The rollers may be disposed radially near the perimeter of the worktop to provide improved stability.

The table may further comprise a plurality of extensions. The extensions may be attached in any suitable configuration for supporting a tire section larger than the worktop of the table. The extensions may have any suitable shape and may be attached in any suitable configuration for supporting a large tire section.

### BRIEF DESCRIPTION OF THE FIGURES

FIG. 1 is a perspective view of a table having optionally attachable extensions according to some embodiments.

FIG. 2 is a top-down view of the table of FIG. 1.

FIG. 3 is a front elevation view of the table of FIG. 1.

FIG. 4 is a side elevation view of the table of FIG. 1.

FIG. 5 is a perspective view of the table of FIG. 1 supporting a tire section and showing a user adjusting the height of the table's worktop; the table is shown without the optional extensions.

FIG. 6. is a perspective view of the table of FIG. 1 with optional extensions attached and a large tire section supported by the worktop and at least one extension.

FIG. 7 is a schematic elevation view of one of the leveling mounts for the table.

### DETAILED DESCRIPTION

While the making and using of various embodiments of the present invention are discussed in detail below, it should be appreciated that the present invention provides many applicable inventive concepts that can be embodied in a wide variety of specific contexts. The specific embodiments discussed herein are merely illustrative of specific ways to make and use the invention and do not delimit the scope of the invention.

To facilitate the understanding of the embodiments described herein, a number of terms are defined below. The terms defined herein have meanings as commonly understood by a person of ordinary skill in the areas relevant to the present invention. Terms such as “a,” “an,” and “the” are not intended to refer to only a singular entity, but rather include the general class of which a specific example may be used for illustration. The terminology herein is used to describe specific embodiments of the invention, but their usage does not delimit the invention, except as set forth in the claims.

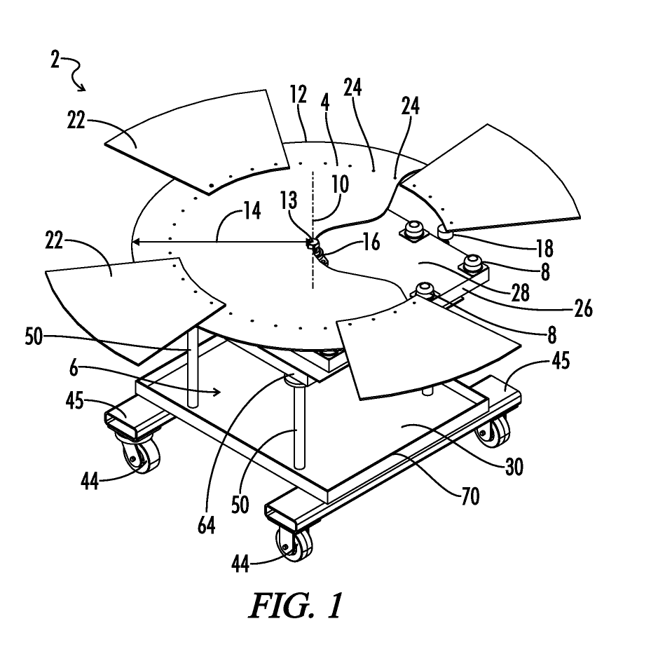

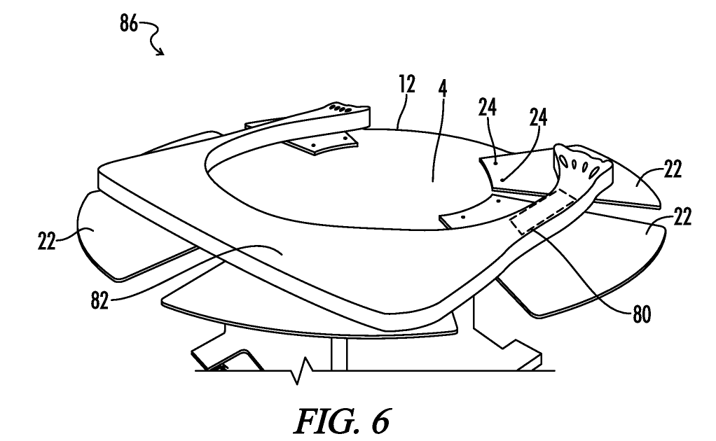

A perspective view of a table 2 is shown in FIG. 1. The table 2 may be configured to improve the ergonomics and efficiency of the buffing process. As shown in FIGS. 1-5, the table 2 may be configured to support and selectively position the tire section 78 for buffing, while also providing stability against the heavy eccentric loading caused by buffing forces and the weight of the tire section 78. Additionally, the table 2 may be configured to be moveable by rollers 44, or similar, attached to the base of the table 2. As shown in FIG. 6, the table 2 may comprise selectively attachable extensions 22 for receiving a tire section 82 larger than the table's worktop 4.

As shown in FIGS. 1-4, the table 2 may comprise a worktop 4, a frame 6, and a plurality of bearings 8. The worktop 4 may include an axis of rotation 10, a perimeter 12, and an effective radius 14. The effective radius 14 may be defined as the average distance between the axis of rotation 10 and the perimeter 12. The worktop 4 may be any shape including, but not limited to circular, square, rectangular, triangular, pentagonal, elliptical etc. A rotational connection 16 may be disposed between the worktop 4 and the frame 6 and configured to allow the worktop 4 to rotate about the axis of rotation 10. As shown in FIGS. 1-4, the worktop 4 may have a circular shape and include a center 13, and the axis of rotation 10 may be aligned with the center 13.

The bearings 8 may be disposed between the worktop 4 and the frame 6 to rollingly support the worktop 4 on the frame 6, and at least one of the bearings 8 may be disposed more than half of the effective radius 14 from the axis of rotation 10. The locations of the bearings 8 may be selected to optimize stability of the worktop 4. For instance, several of the bearings 8 may be located near the perimeter 12 to provide improved stability of the worktop 4 on the frame 6. At least one of the bearings 8 may be disposed more than 75% of the effective radius 14 from the axis of rotation 10.

As shown in FIG. 1, the bearings 8 may be attached to the frame 6 and contacting the worktop 4. However, this configuration is shown by way of example only and not as a necessary limitation. In one embodiment, the bearings 8 may be attached to the worktop 4 and contacting the frame 6. In another embodiment, the bearings may be disposed within a bearing race (not shown) and attached to neither the worktop 4 nor the frame 6, but rather rollingly contacting both the worktop 4 and the frame 6.

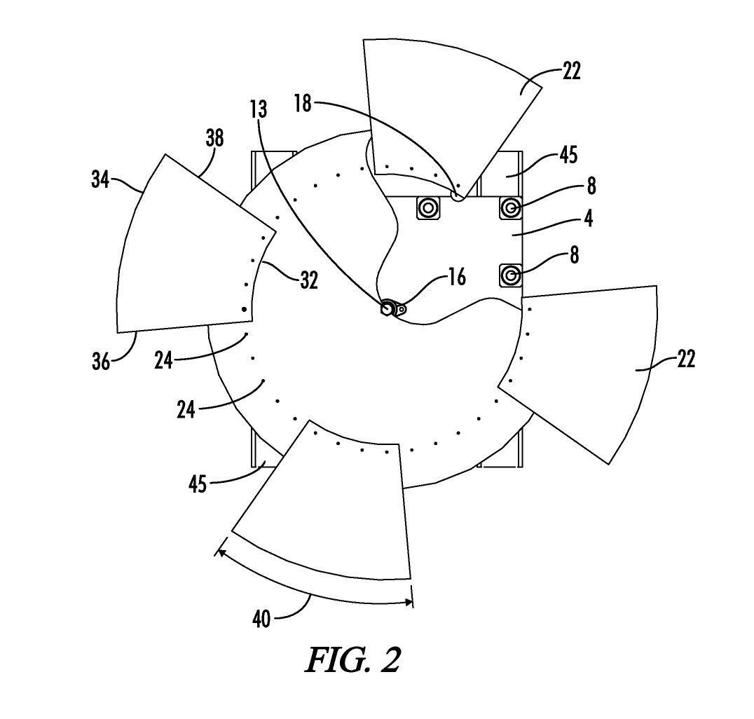

FIGS. 1 and 2 show three bearings 8 disposed on one corner of the table underneath the worktop which is shown cutaway for clarity. In this embodiment, each corner similarly has three bearings disposed thereon. Thus, the table 2 may comprise twelve bearings. However, the table 2 may include any suitable number of bearings.

The bearings 8 may be ball transfers, which are well known in the art. Each ball transfer may include a ball bearing and a housing, the housing rotatably supporting the ball bearing. The housing may be configured to be mounted by flanges and mechanical fasteners or similar. The ball bearing may have a diameter from ½″ to 2″ and may be metal or any suitable material known in the art. However, bearings 8 are not limited to ball transfers and may be any type of bearing known in the art.

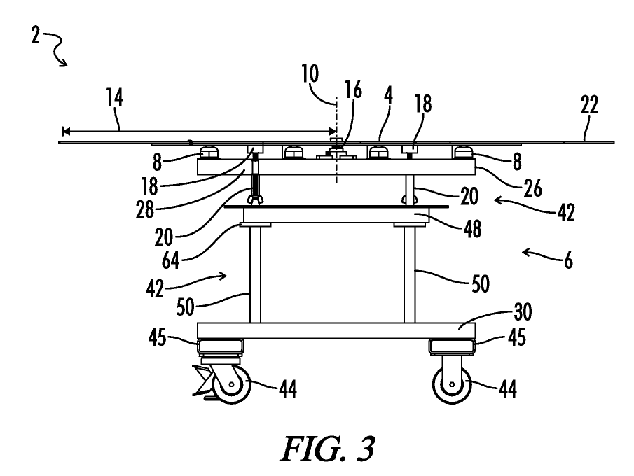

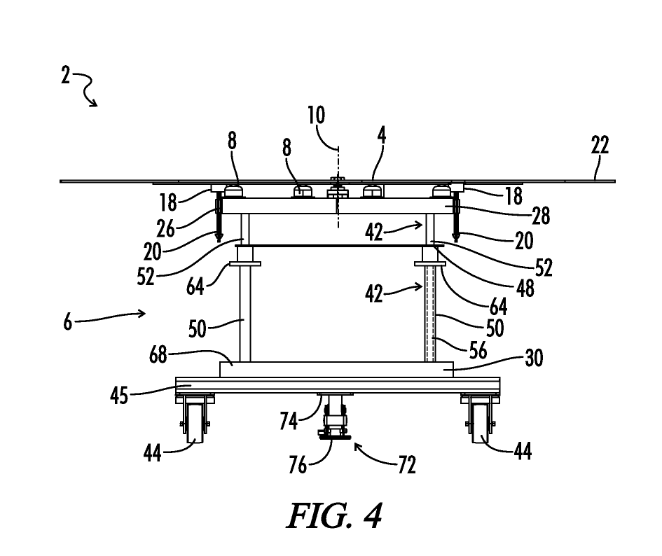

The table 2 may additionally comprise a plurality of leveling mounts 18 and a plurality of leveling mount supports 20. As best seen in FIGS. 3 and 4, each of the mount supports 20 may be configured to selectively raise a respective one of the leveling mounts 18 so that the respective mount 18 bears against the worktop 4 to level the worktop 4. At least one of the mounts 18 may be disposed more than half of the effective radius 14 from the axis of rotation 10. The locations of the leveling mounts 18 may optionally be selected to further optimize stability of the worktop 4. For instance, locating several of the mounts 18 near perimeter 12 may provide improved stability of worktop 4 on frame 6. Referring to FIGS. 1 and 2, frame 6 may include a frame edge 26, and the mounts 18 may be attached to the frame edge 26. However, the locations of the mounts 18 and the mount supports 20 are shown as way of illustration only and not as limitations.

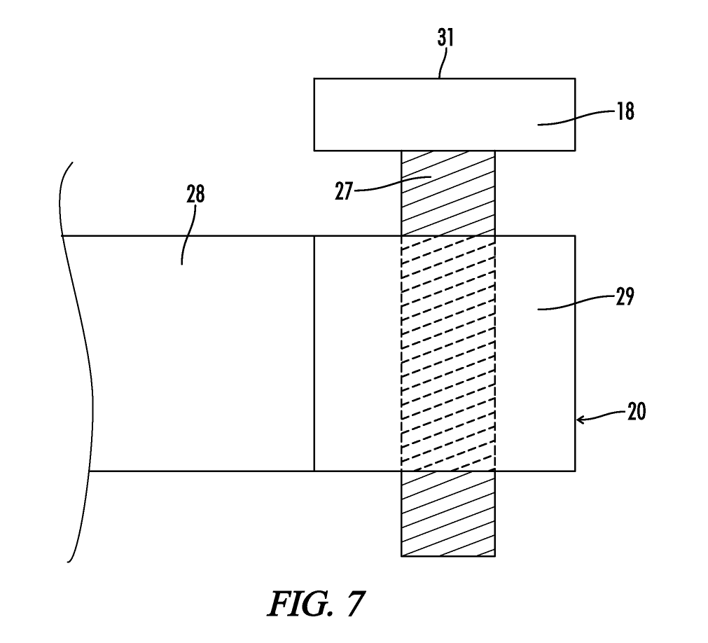

As shown in FIG. 7, each leveling mount 18 and respective mount support 20 may collectively be a screw jack. Screw jacks are well known in the art and may include a threaded screw shaft 27 and a base 29, the threaded screw shaft 27 received in the base 29, the screw shaft 27 configured to be selectively raised and lowered by rotating the screw shaft 27. The leveling mount 18 may be a contacting pad rotatably connected to the screw shaft and include a flat surface 31 disposed on the top side of the mount 18 to contact the worktop 4. The screw jacks may be manually operable.

The frame 6 may include a top frame member 28, a bottom frame member 30, and a plurality of vertical frame members 42. The top frame member 28 and bottom frame member 30 may each define a rectangular shape. The vertical frame members 42 may support the top frame member 28 on the bottom frame member 30, and the rotational connection 16 may be disposed between the worktop 4 and the top frame member 28. The locations of the vertical frame members 42 may be selected to provide increased stability of the top frame member 28 and the worktop 4. For instance, the vertical frame members 42 may be disposed near the perimeter of the worktop 4 in the radial direction as shown in FIGS. 1, 2, and 3.

The plurality of vertical frame members 42 may be configured to selectively raise and lower the top frame member 28. As best seen in FIG. 4, each of the vertical frame members 42 may include a lower tube member 50 and an upper telescoping member 52, the lower tube member 50 defining a cylindrical cavity 56 for receiving the upper telescoping member 52 therein. The table may comprise an intermediate frame member 48 disposed between the top frame member 28 and the bottom frame member 30. The intermediate frame member 48 may be connected to the top of each lower tube member 50 to reinforce each vertical frame member 42 against buckling or other lateral instability. The intermediate frame member 48 may have a plurality of holes 54 defined therein, and each hole 54 may be axially aligned with the cylindrical cavity 56 of each lower tube member 50 for receiving the upper telescoping member 52 therethrough. The intermediate frame member 48 may define a rectangular shape.

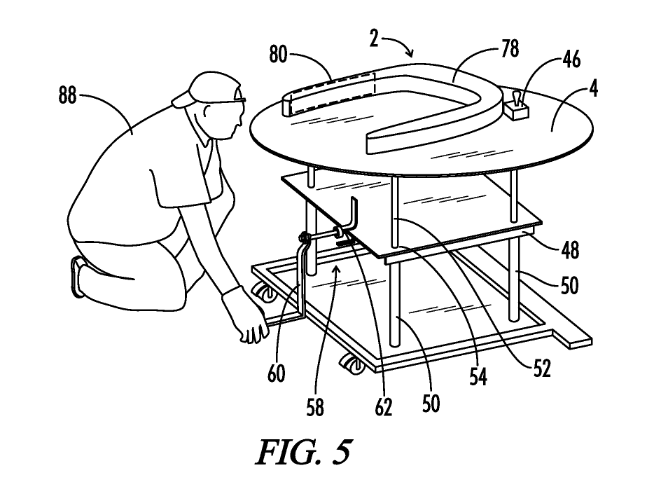

As shown in FIGS. 4 and 5, the table 2 may further comprise a telescoping mechanism 58 to telescope the upper telescoping members 52 upward. The telescoping mechanism 58 may include a crank 60, a gear drive 62 and a plurality of threaded raisers 64. Each of the threaded raisers 64 may be rotatably connected to a respective one of the lower tube members 50. Each of the raisers 64 may threadingly engage a respective one of the upper telescoping members 52 such that rotating a raiser 64 telescopes the respective upper telescoping member 52 upward. The crank 60 may be configured to rotate each of the plurality of raisers 64 such that by turning the crank 60 a user 88 may selectively raise or lower the plurality of upper telescoping members 52 to raise or lower the worktop 4.

As shown in FIG. 4, the bottom frame member 30 may include a foot brake 72 including a foot pedal 74 and a brake surface 76. The foot pedal 74 may be configured to lower the brake surface 76 to contact the ground to prevent translation of the table 2 and lock the table 2 in a selected location.

The table 2 may further comprise a plurality of rollers 44 and a plurality of roller supports 45. The plurality of roller supports 45 may be attached to the bottom frame member 30, each of the roller supports 45 aligned with an edge of the bottom frame member 30, and the roller supports 45 aligned parallel. Two of the rollers 44 may be attached to each roller support 45, each roller 44 disposed at a respective end of the roller support 45.

As best seen in FIG. 1, the bottom frame member 30 may include a vertically protruding edge rib 68 disposed around the edge of the bottom frame member 30. The vertically protruding edge rib 68 may be configured to structurally reinforce the bottom frame member 30 against bending forces. The roller supports 45 may extend beyond the edge of the bottom frame member 30 such that the rollers 44 are disposed at a greater distance from the axis of rotation 10 than the edge of the bottom frame member 30. This arrangement may provide added stability.

Each of the roller supports 45 may be square tubing and may have outer dimensions of ¼ to 1 inch in height and from 3 to 9 inch in width. The rollers 44 may be configured to allow the frame 6 to be translated, and one or more of rollers 44 may be selectively lockable to prevent translation. One or more the rollers 44 may be rotatably mounted to the roller supports 45 to allow one or more rollers 44 to rotate during translation of the table. Allowing one or more rollers 44 to rotate may increase maneuverability of the table during translation. One or more of the rollers 44 may also be rigidly mounted to the roller supports 45 to prevent rotation of the roller 44. Preventing rotation of one or more rollers 44 may increase stability of the table 2 when the table 2 is locked against translation. In one embodiment, two of the rollers 44 may be rotatably mounted and two of the rollers 44 may be rigidly mounted to provide both maneuverability during translation of the table 2 and stability when the table 2 is locked. Each of the rollers 44 may have a diameter from 2 to 8 inches.

As shown in FIG. 6, an expanded table 86 for buffing a large tire section 82 may be configured by attaching a plurality of radially extending extensions 22 to the table 2. The extensions 22 may be configured to be mounted at a plurality of circumferentially spaced mounting locations 24 around the perimeter 12 of the worktop 4 so that a tire section 82 larger than the worktop 4 may be supported on the worktop 4 and one or more of the platform extensions 22. As shown in FIG. 1, there may be a quantity of four extensions 22. As shown in FIG. 6, there may be a quantity of six extensions 22. The number of extensions 22 shown is by way of example only and not a limitation. The extensions 22 may be selectively attached to the worktop 4 and positioned as needed. The extensions 22 may be grouped asymmetrically together in one region of the perimeter 12 as shown in FIG. 6 or evenly spaced around the perimeter 12 as shown in FIG. 1. The table 2 is not limited to any particular arrangement of extensions 22.

The extensions 22, when mounted on the worktop 4, may define spaces therebetween. Further, as shown in FIGS. 1, 2, and 6, each extension 22, when mounted on the worktop 4, may occupy a circumferential angle 40 with respect to the axis of rotation 10, and the total circumferential angle of the plurality of extensions 22 may be in a range between 150 and 300 degrees.

As shown in FIG. 2, each of the extensions 22 may include an inner arcuate edge 32, an outer arcuate edge 34, a first radially extending edge 36, and a second radially extending edge 38. Each extension may include a radial angle 40 between the first radially extending edge 36 and the second radially extending edge 38 such that each extension 22 defines a radially truncated annulus. However, extensions 22 may define any suitable shape including, but not limited to triangular, rectangular, square, etc. The radial angle 40 of each extension may be from 20 to 50 degrees. The arc length of the outer arcuate edge 34 may be from 1 to 3 feet. Dimensions are given by way of example only and not as limitation.

The extensions 22 may be selectively attachable to the worktop 4 using any suitable method known in the art. Specifically, the extensions 22 may be attachable using mechanical fasteners including, but not limited to bolts and rivets. The plurality of extensions 22 may define holes for receiving a plurality of bolts therethough, and the plurality of circumferentially spaced mounting locations 24 may define threaded holes for receiving and securing a threaded portion of each bolt therein. The threaded holes may be defined radially at intervals of 3 to 20 degrees. The plurality of circumferentially spaced mounting locations 24 may be defined radially inward from the perimeter 12 of the worktop 4 such that the extensions 22 are cantilevered from the worktop 4.

As seen in FIG. 5, the table 2 or expanded table 86 may further comprise a plurality of magnetic stops 46, and the stops 46 may be selectively attachable to the worktop 4 and the extensions 22. The stops 46 may be used to secure a tire section against translation relative to the worktop 4 or the extensions 22.

The worktop 4 may be metal, plastic, or any suitable material having sufficient strength to support the weight of a tire section. The worktop 4 may be ¼″ to ½″ thick steel plate. The worktop 4, if circular, may have a diameter from 4 to 7 feet.

As shown in FIG. 5, the table 2 may be used to support and selectively position a section of a tire 78 while a user 88 buffs and inspects the tire section 78. The tire section 78 may be placed on the worktop 4 and a portion 80 of the tire section 78 selected to be buffed. A plurality of magnetic stops 46 may then be selectively positioned around the tire section 78 to secure the tire section 78 relative to the worktop 4. The worktop 4 along with the tire section 78 may be raised or lowered using the crank 60 to actuate the telescoping mechanism 58 to selectively set the height of the tire section 78. The worktop 4 may then be rotated, along with the tire section 78, to a selected orientation that provides increased accessibility of the selected portion 80 of the tire section 78. The table may be locked in the selected orientation by selectively raising the leveling mounts 18 using the leveling mount supports 20 to contact the worktop 4. The leveling mount supports 20 may be used to further raise the leveling mounts 18 to bear against the worktop 4 to level the worktop 4. The user 88 may then buff the selected cross section portion 80. After the buffing process is complete, the user 88 may then use the mount supports 20 to lower the mounts 18 to disengage the mounts 18 from the worktop 4 to allow the worktop 4 to rotate. The user may then repeat the rotating, raising/lowering, locking/leveling, and buffing steps for another selected cross section portion 80 at another worktop orientation.

As shown in FIG. 6, the expanded table 86 may be configured by adding extensions 22 to the worktop 4 to accommodate a large tire section 82. The large tire section 82 may be larger than the worktop 4. The extensions 22 may be selectively attached at selected mounting locations 24 as needed. The extensions 22 may be attached in any configuration the user 88 selects. The above discussed process of rotating, raising/lowering, leveling, and buffing the tire section 78 applies equally to the expanded table 86 with a large tire section 82.

Thus it is seen that the apparatus and methods of the present invention readily achieve the ends and advantages mentioned as well as those inherent therein. While certain preferred embodiments of the invention have been illustrated and described for purposes of the present disclosure, numerous changes in the arrangement and construction of parts and steps may be made by those skilled in the art, which changes are encompassed within the scope and spirit of the present invention as defined by the appended claims.

What is claimed is:

1. A table comprising:
a worktop including an axis of rotation, a perimeter, and an effective radius, the effective radius defined as the average distance between the axis of rotation and the perimeter;
a frame;
a rotational connection disposed between the worktop and the frame, the connection configured to allow the worktop to rotate about the axis of rotation; and
a plurality of bearings disposed between the worktop and the frame to rollingly support the worktop on the frame, at least one of the bearings disposed more than half of the effective radius from the axis of rotation.

2. The table of claim 1, wherein the bearings are attached to the frame and contact the worktop.

3. The table of claim 1, wherein:
the frame includes a plurality of sides and a plurality of corners; and
the plurality of bearings are arranged such that a bearing is disposed at each corner and a bearing is disposed along each side.

4. The table of claim 1, further comprising:
a plurality of leveling mounts; and
a plurality of leveling mount supports, each of the supports configured to selectively raise a respective one of the mounts so that the respective mount bears against the worktop to level the worktop, and at least one of the leveling mounts disposed more than half of the effective radius from the axis of rotation.

5. The table of claim 4, wherein the leveling mount supports comprise screw jacks.

6. The table of claim 4, wherein:
the frame includes a frame edge; and
the leveling mount supports are attached to the frame edge.

7. The table of claim 1, wherein the table is for buffing a section of a tire, the table further comprising a plurality of radially extending extensions configured to be mounted at a plurality of circumferentially spaced mounting locations around the perimeter of the worktop, so that a tire section larger than the worktop may be supported on the worktop and one or more of the extensions.

8. The table of claim 7, wherein the extensions define spaces therebetween when mounted on the worktop.

9. The table of claim 7, wherein each extension, when mounted on the worktop, occupies a circumferential angle with respect to the axis of rotation, the total circumferential angle of the plurality of extensions being in a range of from 150 to 300 degrees.

10. The table of claim 7, wherein:
the worktop is circular; and
each of the extensions, when mounted on the worktop, include an inner arcuate edge, an outer arcuate edge, a first radially extending edge, and a second radially extending edge, each extension including a radial angle between the first radially extending edge and the second radially extending edge such that each extension defines a radially truncated annulus.

11. The table of claim 1, wherein the frame comprises a top frame member, a bottom frame member, and a plurality of vertical frame members, the vertical frame members supporting the top frame member on the bottom frame member, the rotational connection disposed between the worktop and the top frame member.

12. The table of claim 11, wherein the vertical frame members are operably configured to selectively raise and lower the top frame member.

13. The table of claim 1, wherein the table is for buffing a section of a tire, the table further comprising a plurality of magnetic stops, the stops configured to be selectively attachable to the worktop to secure the tire section against translation relative to the worktop.

14. A table comprising:
a top including a rotational axis, an outer edge, and an effective radius, the effective radius defined as the average distance between the rotational axis and the outer edge;
a frame;
a rotational connection disposed between the top and the frame, the connection configured to allow the top to rotate about the rotational axis;
a plurality of leveling mounts; and
a plurality of leveling mount supports, each of the supports configured to selectively raise a respective one of the mounts so that the respective mount bears against the top to level the top, and at least one of the leveling mounts is disposed more than half of the effective radius from the rotational axis.

15. A table for buffing a section of a tire, comprising:
a frame;
a central platform rotatably mounted on the frame, the platform including an axis of rotation and an outer edge; and
a plurality of radially extending extensions configured to be mounted at a plurality of circumferentially spaced mounting locations around the outer edge of the central platform so that a tire section larger than the central platform may be supported on the central platform and one or more of the platform extensions.

16. The table of claim 15, wherein each extension, when mounted on the central platform, occupies a circumferential angle with respect to the axis of rotation, the total circumferential angle of the plurality of extensions being between 150 and 300 degrees.

17. The table of claim 15, wherein:
the central platform is circular; and
each of the extensions, when mounted on the central platform, include an inner arcuate edge, an outer arcuate edge, a first radially extending edge, and a second radially extending edge, each extension including a radial angle between the first radially extending edge and the second radially extending edge such that each extension defines a radially truncated annulus.

18. A method of buffing a cross section of a tire, the method comprising:
(a) placing the cross section on a worktop, the worktop rotatably supported by a frame;
(b) selecting a cross section portion to buff;
(c) rotating the worktop to a selected orientation to increase accessibility of the selected cross section portion;
(d) buffing the selected cross section portion; and
(e) repeating steps (b) through (d) for another selected cross section portion and selected orientation.

19. The method of claim 18, further comprising leveling the worktop in the selected orientation.

20. The method of claim 19, wherein leveling the worktop comprises raising one or more of a plurality of leveling mounts to bear against the worktop to level the worktop, each mount configured to be selectively raised by a respective leveling mount support.

21. The method of claim 18, wherein the frame comprises a top frame member, a bottom frame member, and a plurality of vertical frame members, the vertical frame members supporting the top frame member on the bottom frame member, the top frame member rotatably supporting the worktop, and the vertical members operably configured to selectively raise and lower the top frame member, the method further comprising:
vertically positioning the worktop by raising or lowering the top frame member.

22. The method of claim 18, wherein step (a) further comprises:
attaching a plurality of radially protruding table extensions to the worktop to effectively increase the size of the worktop.
